(19) United States
(12) Patent Application Publication
(10) Pub. No.: US 2012/0001500 A1
(43) Pub. Date: Jan. 5, 2012

(54) Stepping Motor

(76) Inventors: Dong-Hwan OH, Buchun-city (KR); Taek-Hoe Song, Incheon-city (KR)

(21) Appl. No.: 13/167,413

(22) Filed: Jun. 23, 2011

(30) Foreign Application Priority Data
Jul. 1, 2010 (KR) 10-2010-0063238

(51) Int. Cl. H02K 5/02

(52) U.S. Cl. 310/43

(57) ABSTRACT

Disclosed herein is a stepping motor for a slim optical disk drive (ODD). A casing which protects and covers a stator of a motor part is divided into two casing parts, and a casing part adjacent to an end of a rotating shaft has at least two insert holes in an end plate thereof. Thus, a support member which supports a center guide is fastened to the casing in such a way that the support member is inserted into the insert holes. The casing part adjacent to the end of the rotating shaft is integrally formed with the support member by insert molding. Therefore, the stepping motor of the present invention can satisfy the trend of a reduction in size and thickness.

### BACKGROUND OF THE INVENTION

1. Field of the Invention

The present invention relates generally to stepping motors for slim optical disk drives (ODDs) and, more particularly, to a stepping motor which has an improved casing structure in which a casing which protects and covers a stator of a motor part is divided into two casing parts, and a casing part adjacent to an end of a rotating shaft has at least two insert holes in an end plate thereof so that a support member which supports a center guide is fastened to the casing by inserting it into the insert holes, wherein the casing part adjacent to the end of the rotating shaft is integrally formed with the support member by insert molding, thus satisfying the trend of a reduction in size and thickness.

2. Description of the Related Art

Generally, stepping motors for optical disk drives (ODDs) include a motor part and a lead screw. The motor part includes a rotor, a stator, and a casing. The rotor has a rotating shaft and a magnet provided on the circumferential outer surface of the rotating shaft. The stator is provided around the circumferential outer surface of the rotor with a predetermined distance therebetween. The casing protects and covers the stator. The lead screw is axially coupled to the rotating shaft of the motor part. The stepping motors function to linearly reciprocate an optical pickup to enable the optical pickup to read data from a disk that is placed on an ODD and is rotating.

Recently, to accommodate the trend of a reduction in size and thickness, stepping motors for ODDs have been manufactured in a small and thin shape which has a rectangular peripheral surface and the maximum outer diameter of 8 mm or less. In the conventional technique, to satisfy required high torque despite having the reduced outer diameter, the motor part is long in comparison with the reduced outer diameter.

However, the reduction in size and thickness of the conventional stepping motors for ODDs reduces the mechanical strength of the stepping motors and, particularly, causes a problem of a reduction in resistance to shock. Furthermore, of ODDs which have been recently developed, a BLU-RAY ODD uses two lens devices. However, installation of two lens devices makes it difficult to design an inner layout of an ODD.

To overcome these problems, the motor part must be comparatively short. For this, a technique was proposed in which protrusions made of metal or resin are integrally formed on the outer surface of the casing by insert molding as an attempt to reduce the size of a structure for supporting a ball bearing and a center guide which support one end of the rotating shaft of the motor part.

However, in this conventional technique, several steps of forming processes are required to form the protrusions on the outer surface of the casing. Thus, the manufacturing process is complicated. Furthermore, because the protrusions are made of metal or resin, they may be easily bent. Thereby, the center guide that is supported by the protrusions may not be reliable, thus causing malfunction of the motor part.

### SUMMARY OF THE INVENTION

Accordingly, the present invention has been made keeping in mind the above problems occurring in the prior art, and an object of the present invention is to provide a stepping motor which has an improved casing structure in which a casing which protects and covers a stator of a motor part is divided into two casing parts, and a casing part adjacent to an end of a rotating shaft has at least two insert holes in an end plate thereof so that a support member which supports a center guide is fastened to the casing by inserting it into the insert holes, wherein the casing part adjacent to the end of the rotating shaft is integrally formed with the support member by insert molding, thus satisfying the trend of a reduction in size and thickness.

Another object of the present invention is to provide a stepping motor in which a plurality of yoke teeth are integrally formed on a circumferential inner surface of the casing of the motor part so that the number of elements of the motor part is reduced, and which can provide sufficient torque despite a reduction in the whole length of the motor part.

In order to accomplish the above object, the present invention provides a stepping motor including: a rotor comprising a rotating shaft and a magnet provided around a circumferential outer surface of the rotating shaft; a stator provided around a circumferential outer surface of the rotor with a predetermined distance therebetween; a center guide provided on an end of the rotating shaft to support the rotating shaft; and a casing protecting and covering the stator, the casing being divided into two casing parts disposed on opposite sides of a terminal block. The casing part adjacent to the end of the rotating shaft has at least two insert holes in an end plate thereof, and a support member is fastened to the casing part in such a way that the support member is inserted into the insert holes of the casing part, the support member supporting the center guide, wherein the casing part adjacent to the end of the rotating shaft is integrally formed with the support member by insert molding.

Preferably, a plurality of yoke teeth may be integrally formed on a circumferential inner surface of the casing part adjacent to the end of the rotating shaft.

Furthermore, the insert holes may be formed by punching or drilling.

In addition, a cross-section of a circumferential outer surface of the casing adjacent to the end of the rotating shaft may have one shape selected from among a circular shape, a rectangular shape, an elliptical shape, a circular shape having two linear sides and an elliptical shape having two linear sides. Preferably, a maximum outer diameter of a circumferential outer surface of the casing may be 8 mm or less.

The stepping motor may further include an elastic member coupled to the support member in such a way that the elastic member covers an end of the support member, with an elastic piece provided on a central portion of the elastic member so that the elastic piece applies a pre-load to the center guide to push the center guide towards the rotating shaft.

The support member may have a locking protrusion and the elastic member may have a bent locking end so that the elastic member is coupled to the support member by locking the bent locking end of the elastic member to the locking protrusion of the support member. The bent locking end of the elastic member may be formed by bending at least two portions thereof.

Furthermore, at least two semicircular reinforcing notches may be formed at diametrically opposite positions in a circumferential inner edge of the end plate of the casing part adjacent to the end of the rotating shaft.

In a stepping motor according to the present invention, a casing which protects and covers a stator of a motor part is divided into two casing parts. A casing part adjacent to an end of a rotating shaft has at least two insert holes in an end plate thereof. A support member which supports a center guide is fastened to the casing part by inserting the support member into the insert holes of the casing part. The casing part adjacent to the end of the rotating shaft is integrally formed with the support member by insert molding. As such, the present invention improves the structure of the casing of the motor part, thus making it possible to manufacture a stepping motor suitable for the trend of a reduction in size and thickness.

Furthermore, a plurality of yoke teeth are integrally formed on a circumferential inner surface of the casing of the motor part. Thus, the number of elements of the stepping motor can be reduced, thus reducing the production cost. In addition, the whole length of the motor part can be reduced despite maintaining the same torque, compared to the conventional technique.

Moreover, in the present invention, the size and thickness of the motor part can be reduced despite maintaining sufficient torque without simply reducing the length of the casing or the lengths other important elements to reduce the whole length of the motor part.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing the entire construction of a stepping motor, according to the present invention;

FIG. 2 is an enlarged view of a motor part of the stepping motor of FIG. 1;

FIG. 3 is a plan view showing an embodiment of a casing of the stepping motor according to the present invention; and

FIG. 4 is a sectional view taken along line B-B′ of FIG. 3.

### DESCRIPTION OF THE PREFERRED EMBODIMENTS

Hereinafter, a stepping motor according to the present invention will be described in detail with reference to the attached drawings.

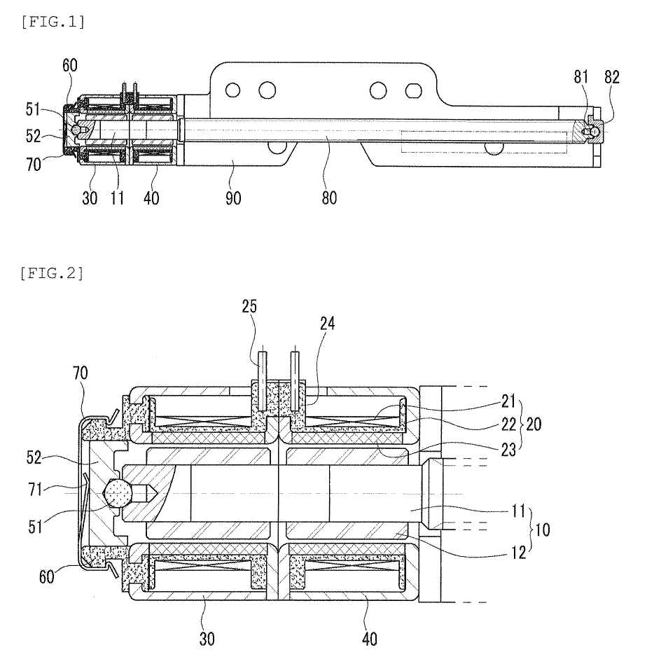

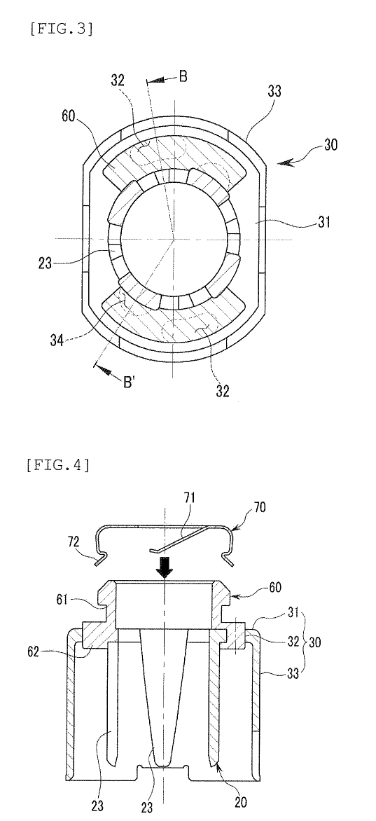

FIG. 1 is a view showing the entire construction of the stepping motor, according to the present invention. FIG. 2 is an enlarged view of a motor part of the stepping motor of FIG. 1. FIG. 3 is a plan view showing an embodiment of a casing of the stepping motor according to the present invention. FIG. 4 is a sectional view taken along line B-B′ of FIG. 3, showing coupling of an elastic member to the casing.

As shown in FIGS. 1 and 2, the stepping motor according to the present invention includes a motor part and a lead screw 90. The motor part includes a rotor 10, a stator 20, and a casing 30 and 40. The rotor 10 includes a rotating shaft 11 and a magnet 12 which is provided on a circumferential outer surface of the rotating shaft 11. The stator 20 includes a bobbin 22 which is provided around a circumferential outer surface of the rotor 10 with a predetermined distance therebetween, and a yoke which has a plurality of yoke teeth 23. A coil 21 is wound around the bobbin 22. The casing 30 and 40 covers the stator 20. The lead screw 80 is axially coupled to the rotating shaft 11 of the motor part. A first end of the lead screw 80 is supported by a bracket 90, and a second end thereof is supported by a bearing 81 and a pivot bearing 82 so as to be reversibly rotatable.

The structure of the motor part which includes the rotor 10 and the stator 20 and the structure of the lead screw 80 which is axially coupled to the rotating shaft 11 of the motor part are well known and are not distinctive characteristics of the present invention, therefore further detailed explanation will be omitted.

The casing 30 and 40 is divided into two casing parts 30 and 40 which are disposed on opposite sides of a terminal block 24. In FIGS. 1 and 2, the casing part (30, the casing part adjacent to an end of the rotating shaft) which is disposed at the left side of the terminal block 24 is coupled at one end thereof to the casing part 40 disposed at the right side of the terminal block 24 to protect and cover the stator 20. The casing part 30 is integrally formed with a support member 60 by insert molding, which will be described later herein. The casing part 40 which is disposed at the right side of the terminal block 24 is configured in such a way that a right end thereof covers a right end of the stator 20.

In an embodiment, as shown in FIG. 3, although the cross-section of a circumferential outer surface of each of the casing parts 30 and 40 is illustrated as having two linear parallel sides and two outwardly curved sides, it may have any one shape selected from among a circular shape, a rectangular shape, an elliptical shape, a circular shape having two linear sides, and an elliptical shape having two linear sides, so long as the maximum outer diameter of the circumferential outer surface thereof is preferably 8 mm or less.

Meanwhile, in the motor part, a bearing 51 and a center guide 52 are provided on the end of the rotating shaft 11 that is disposed at a position opposite to the lead screw 80 so that the rotating shaft 11 is axially rotatably supported by the bearing 51 and the center guide 52.

As shown in FIG. 4, the casing part 30 which is disposed at the left side of the terminal block 24, in other words, adjacent to the first end of the rotating shaft 11, integrally has a plurality of yoke teeth on a circumferential inner surface thereof so as to reduce the whole length of the motor part and the number of assembly processes.

The support member 60 is provided around a circumferential outer surface of the center guide 52 to prevent the center guide 52 from undesirably moving in an axial direction or a radial direction. An elastic member 70 is fitted over an end of the support member 60 in such a way that it covers the end of the support member 60. The elastic member 70 functions to apply a pre-load to the center guide 52 to push the center guide 52 towards the rotating shaft 11.

As shown in FIGS. 3 and 4, the casing part 30 includes an end plate (31, an upper horizontal surface when viewed in FIG. 4), and a circumferential surface which vertically extends from the outer edge of the end plate 31. The circumferential surface 33 has an open lower end. Two elliptical insert holes are formed in the end plate 31 at predetermined diametrically opposite positions. The support member 60 includes insert parts 62 which are inserted into the respective insert holes 32 so that the support member 60 is fastened to the casing part 30. The insert parts 62 are integrally formed with the support member 60 by insert molding. The insert holes 32 are formed by a machining method, such as punching or drilling.

In FIGS. 3 and 4, although the casing part 30 is illustrated as having the two elliptical insert holes 32, the insert holes 32 may have other shapes as well as an elliptical shape, and the number of insert holes 32 may exceed two. Preferably, the insert holes 32 comprise two to four insert holes 32.

Furthermore, two reinforcing notches 34 each of which has an approximately semicircular shape are formed in a circumferential inner edge of the end plate 32 at predetermined diametrically opposite positions to reinforce the casing part 30.

As shown in FIG. 3, the support member 60 comprises two support members 60 which are provided at diametrically opposite positions. Each support member 60 has an arc shape and a predetermined thickness. As shown in FIG. 4, a locking protrusion 61 is provided on the end of each arc-shaped support member 60.

In addition, the elastic member 70 is coupled to the support members 60 in such a way that the elastic member 70 covers the ends of the support members 60.

In detail, the elastic member 70 includes bent locking ends 72 which are provided at positions corresponding to the respective locking protrusions 61 of the support member 60 so that the elastic member 70 is elastically coupled to the locking protrusions 61 of the support member 60 by the bent locking ends 72. It is preferable that the locking end 72 be formed by bending at least two portions thereof so that it is more reliably elastically coupled to the corresponding locking protrusion 61 of the support member 60.

Moreover, an elastic piece 71 is provided on a central portion of the elastic member 70. The elastic piece 71 applies a pre-load to the center guide 52 to push the center guide 52 towards the rotating shaft 11. Preferably, the elastic piece 71 is a plate spring.

In the present invention, the above-mentioned structure of the casing part 30 makes it possible to manufacture a stepping motor suitable for the trend of a reduction in size and thickness. Because the number of elements is reduced, the production cost can be reduced. Furthermore, the whole length of the motor part can be reduced despite maintaining the same torque, compared to the conventional technique.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A stepping motor comprising: a rotor comprising a rotating shaft and a magnet provided around a circumferential outer surface of the rotating shaft; a stator provided around a circumferential outer surface of the rotor with a predetermined distance therebetween; a center guide provided on an end of the rotating shaft to support the rotating shaft; and a casing protecting and covering the stator, the casing being divided into two casing parts disposed on opposite sides of a terminal block,
wherein the casing part adjacent to the end of the rotating shaft has at least two insert holes in an end plate thereof, and a support member is fastened to the casing part in such a way that the support member is inserted into the insert holes of the casing part, the support member supporting the center guide, wherein the casing part adjacent to the end of the rotating shaft is integrally formed with the support member by insert molding.

2. The stepping motor as set forth in claim 1, wherein a plurality of yoke teeth are integrally formed on a circumferential inner surface of the casing part adjacent to the end of the rotating shaft.

3. The stepping motor as set forth in claim 1, wherein the insert holes are formed by punching or drilling.

4. The stepping motor as set forth in claim 1, wherein a cross-section of a circumferential outer surface of the casing adjacent to the end of the rotating shaft has one shape selected from among a circular shape, a rectangular shape, an elliptical shape, a circular shape having two linear sides and an elliptical shape having two linear sides.

5. The stepping motor as set forth in claim 1, wherein a maximum outer diameter of a circumferential outer surface of the casing is 8 mm or less.

6. The stepping motor as set forth in claim 1, further comprising:
an elastic member coupled to the support member in such a way that the elastic member covers an end of the support member, with an elastic piece provided on a central portion of the elastic member so that the elastic piece applies a pre-load to the center guide to push the center guide towards the rotating shaft.

7. The stepping motor as set forth in claim 6, wherein the elastic piece comprises a plate spring.

8. The stepping motor as set forth in claim 6, wherein the support member has a locking protrusion and the elastic member has a bent locking end so that the elastic member is coupled to the support member by locking the bent locking end of the elastic member to the locking protrusion of the support member.

9. The stepping motor as set forth in claim 8, wherein the bent locking end of the elastic member is formed by bending at least two portions thereof.

10. The stepping motor as set forth in claim 1, wherein at least two semicircular reinforcing notches are formed at diametrically opposite positions in a circumferential inner edge of the end plate of the casing part adjacent to the end of the rotating shaft.
